(19) United States
(12) Patent Application Publication
(10) Pub. No.: US 2015/0081240 A1
(43) Pub. Date: Mar. 19, 2015

(54) SYSTEM AND METHOD FOR GENERATING A TEST FILE

(71) Applicants: SHENZHEN FUTAIHONG PRECISION INDUSTRY CO., LTD., Shenzhen (CN); Chiun Mai Communication Systems, Inc., New Taipei (TW)

(72) Inventors: QI-YAN ZHENG, Shenzhen (CN); LONG-HU FENG, Shenzhen (CN); HUA ZHUANG, Shenzhen (CN); GUO-ZENG ZHENG, Shenzhen (CN); JUNG-CHEN LIANG, New Taipei (TW)

(21) Appl. No.: 14/485,950

(22) Filed: Sep. 15, 2014

(30) Foreign Application Priority Data
Sep. 17, 2013 (CN) 201310424184.X

(51) Int. Cl. G01D 9/00; G01B 21/02; G05B 21/02

(52) U.S. Cl. CPC G01D 9/00; G05B 21/02; G01B 21/02
USPC 702/83

(57) ABSTRACT

A test system for generating a test file includes an information obtaining module, a file header generation module, an identification module, and a measuring module. The information obtaining module reads an original information of an electronic component. The file header generation module generates a file header according to the original information. The identification module determines a manufacturing process of the electronic component according to the original information, and generates test items according to the manufacturing process. The measuring module activates measuring program according to the manufacturing process to measure the electronic device for obtain a measuring result corresponding to the test items.

### FIELD

The subject matter herein generally relates to electronic components testing methods, and more particularly to a system and method for generating a test file of the electronic components using a test computer.

### BACKGROUND

It is very important to test 3-dimensional sizes of an electronic component during a manufacturing process. At present, an image of the electronic component is captured by a charge-coupled device (CCD) sensor, and the 3-dimensional sizes of the electronic component are usually recorded manually according to the image to generate a test file.

### BRIEF DESCRIPTION OF THE DRAWINGS

Implementations of the present technology will now be described, by way of example only, with reference to the attached figures.

FIG. 1 is a block diagram of one embodiment of a test system for generating a test file.

FIG. 2 is a flowchart of one embodiment of a method for generating a test file using the test system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a test system and method for generating a test file.

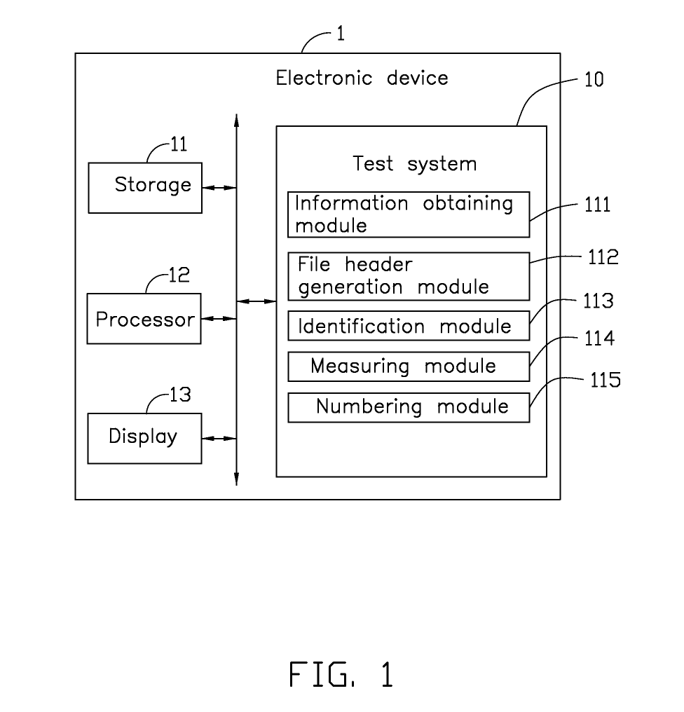

FIG. 1 is a block diagram of one embodiment of a test system 10 used in an electronic device 1 for generating a test file of an electronic component. The electronic device 1 can be a test computer or other test equipment. The test file at least includes 3-dimensional sizes of the electronic component.

The electronic device 1 further includes a storage 11, a processor 12, and a display 13. In at least one embodiment, the test system 10 may include computerized instructions in the form of one or more programs, which are stored in the storage 11 and executed by the processor 12 to perform operations of the electronic device 1. The display 13 is used to show relevant data, such as the test file, for example.

In at least one embodiment, the test system 10 may include one or more modules, for example, an information obtaining module 111, a file header generation module 112, an identification module 113, a measuring module 114, and a numbering module 115. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The information obtaining module 111 reads original information of the electronic component from an electronic application document. In at least one embodiment, the original information may include device identifications, device manufacturers, and client information. The original information can be pre-recorded on the electronic application document.

The file header generation module 112 generates a file header on a template document according to the original information obtained by the information obtaining module 111. The template document can be opened in advance, and a document type of the template document can be an EXCEL format, a WORD format, or other relevant format. In at least one embodiment, the template document is the EXCEL format. The file header is a part of the test file, and includes the device identifications, the device manufacturers, and the client information.

The identification module 113 determines a manufacturing process of the electronic component according to the original information obtained by the information obtaining module 111, and generates test items on the template document according to the manufacturing process. In at least one embodiment, each of the device identifications corresponds to a manufacturing process, and a corresponding relationship between the device identifications and the manufacturing processes is pre-stored in the storage 11. Thus, the identification module 113 identifies the device identifications, thereby determining the manufacturing processes and generating the test items accordingly. In at least one embodiment, the manufacturing processes of the electronic component can include a molding process, an assembling process, a painting process, a printing process, and an electroplating process. For example, when the molding process is determined, the identification module 113 generates a first test item of “3-dimensional sizes of a first electronic component” and a second test item of “3-dimensional sizes of a second electronic component”. When the painting process is determined, the identification module 113 generates a third test item of “3-dimensional sizes” and a fourth test item of “error”.

The measuring module 114 activates a measuring apparatus and measuring program corresponding to the measuring apparatus according to the manufacturing process of the electronic component, for measuring the 3-dimensional sizes of the electronic component. In at least one embodiment, each manufacturing process corresponds to a measuring apparatus and measuring program, and the measuring program is pre-stored in the storage 11 to drive the measuring apparatus. In addition, a measuring result of the measuring module 114 corresponds to the test items generated by the identification module 113, and is automatically recorded on the template document. For example, in the molding process, the measuring module 114 activates a charge-coupled device (CCD) sensor and corresponding measuring program to measure the 3-dimensional sizes of the electronic component. Since the measuring module 114 can activate different measuring apparatus and different measuring program corresponding to different manufacturing processes, thus, the test system 100 is precise and efficient.

The numbering module 115 allocates a serial number for the template document, thereby generating the test file.

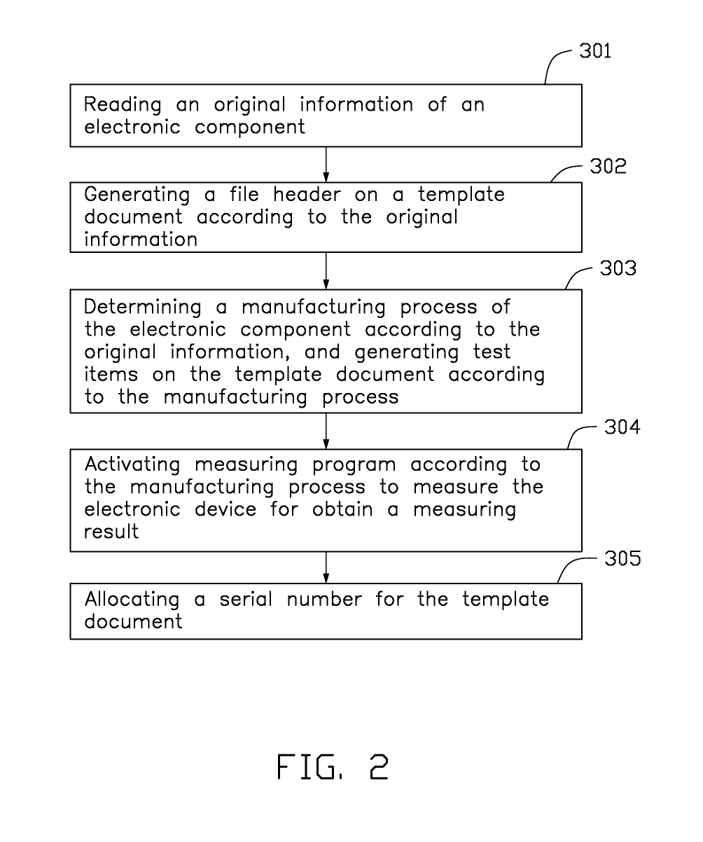

FIG. 2 illustrates a flowchart of an example embodiment of a method for automatically testing signal integrity of an electronic product. In an example embodiment, the method is performed by execution of computer-readable software program codes or instructions by at least one processor of a computing device, and can automatically test signal integrity of electronic components of the electronic product.

Referring to FIG. 2, a flowchart is presented in accordance with an example embodiment. The example method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods, or subroutines, carried out in the example method. Furthermore, the illustrated order of blocks is illustrative only and the order of the blocks can be changed. Additional blocks can be added or fewer blocks may be utilized without departing from this disclosure. The example method can begin at block 301.

At block 301, the information obtaining module reads the original information of the electronic component from the electronic application document to obtain device identifications, device manufacturers, and client information.

At block 302, the file header generation module generates the file header on the template document according to the original information obtained by the information obtaining module.

At block 303, the identification module determines the manufacturing process of the electronic component according to the original information obtained by the information obtaining module, and generates the test items on the template document according to the manufacturing process.

At block 304, the measuring module activates the measuring apparatus and the corresponding measuring program according to the manufacturing process of the electronic component, for measuring the 3-dimensional sizes of the electronic component. A measuring result of the measuring module corresponds to the test items, and is automatically recorded on the template document.

At block 305, the numbering module allocates the serial number for the template document, thereby generating the test file.

In other embodiment, the measuring result can further include color or mechanical strength of the electronic component. At this time, the identification module 113 generates test items corresponding to the color and the mechanical strength, and the 114 activates a measuring apparatus and measuring program corresponding to the color and the mechanical strength.

In summary, the test system 100 reads the original information of the electronic component and generates the file header and the test items accordingly. Thus, a measuring apparatus and measuring program are applied to the electronic component to obtain the measure result. Therefore, the file header, the test items, and the measuring result on the template document are constituted to the test file, thus, the test system 100 is both convenient and efficient.

The embodiments shown and described above are only examples. Many details are often found in the art such as the other features of a test system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method for generating a test file, the method comprising:
reading an original information of an electronic component;
generating a file header according to the original information;
determining a manufacturing process of the electronic component according to the original information, and generating test items according to the manufacturing process; and
activating measuring program according to the manufacturing process to measure the electronic device for obtain a measuring result corresponding to the test items;
wherein the file header, the test items, and the measuring result are constituted to the test file.

2. The method as claimed in claim 1, wherein the file header, the test items, and the measuring result are formed on a template document.

3. The method as claimed in claim 2, wherein the template document is opened in advance.

4. The method as claimed in claim 2, further comprising allocating a serial number for the template document.

5. The method as claimed in claim 1, wherein the original information includes device identification, the manufacturing process corresponds to the device identification.

6. The method as claimed in claim 1, wherein the measuring result comprises 3-dimensional sizes of the electronic device.

7. A test system for generating a test file, the test system comprising :
an information obtaining module reading an original information of an electronic component;
a file header generation module generating a file header according to the original information;
an identification module determining a manufacturing process of the electronic component according to the original information, and generating test items according to the manufacturing process; and
a measuring module activating measuring program according to the manufacturing process to measure the electronic device for obtain a measuring result corresponding to the test items;
wherein the file header, the test items, and the measuring result are constituted to the test file.

8. The test system as claimed in claim 7, wherein the file header, the test items, and the measuring result are formed on a template document.

9. The test system as claimed in claim 8, wherein the template document is opened in advance.

10. The test system as claimed in claim 8, further comprising a numbering module, wherein the numbering module allocates a serial number for the template document.

11. The test system as claimed in claim 7, wherein the original information includes device identification, the manufacturing process corresponds to the device identification.

12. The test system as claimed in claim 11, wherein the identification module determines the manufacturing process according to the device identification.

13. The test system as claimed in claim 7, wherein the measuring result comprises 3-dimensional sizes of the electronic device.
